(19) United States
(12) Patent Application Publication
(10) Pub. No.: US 2021/0325899 A1
(43) Pub. Date: Oct. 21, 2021

(54) SYSTEMS AND METHODS FOR CONTROLLING A DISCHARGE RATE OF A HAULING MACHINE

(71) Applicant: Caterpillar Inc., Peoria, IL (US)

(72) Inventors: Kenneth Franklin Grambihler, Peoria, IL (US); James Wilber Landes, East Peoria, IL (US); Harry Paul Newton, Sahaurita, AZ (US); Joseph E. Tabor, Germantown Hills, IL (US); Brad Robert Van De Veer, Washington, IL (US); Stefan Wulf, Washington, IL (US)

(73) Assignee: Caterpillar Inc., Peoria, IL (US)

(21) Appl. No.: 16/854,723

(22) Filed: Apr. 21, 2020

(51) Int. Cl. G05D 1/02; G01C 21/00; G07C 5/00; G07C 5/08; B02C 25/00; B02C 23/02

(52) U.S. Cl. CPC G05D 1/0276; G05D 1/0212; G01C 21/005; G07C 5/008; B60P 1/04; B02C 25/00; B02C 23/02; G05D 2201/0202; G07C 5/0841

(57) ABSTRACT

A system includes one or more processors configured to determine a discharge rate associated with discharging material from a hauling machine. In some examples, the system receives sensor data associated with a crushing machine configured to receive the material. Based on the sensor data, the system determines the discharge rate, to optimize the efficiency of the crushing machine. In some examples, the system determines the discharge rate based on input by an operator via a user interface. In some examples, the system determines an angular rate at which to raise a bed of the hauling machine to cause the material to be discharged at the discharge rate. Based on a determination to discharge material, the system causes the bed to be raised at the angular rate to discharge material. In some examples, the system may update the discharge rate based on additional sensor data and/or an additional operator input.

### TECHNICAL FIELD

The present disclosure relates to systems and methods for controlling a discharge rate of a hauling machine (e.g., haul truck, dump truck, etc.). More specifically, the present disclosure relates to systems and methods for determining a discharge rate of the dumping machine based at least in part on a material to be discharged and/or a capability or capacity of a receiving machine (e.g., crusher).

### BACKGROUND

Hauling machines are used to transfer material between locations. A hauling machine discharges material using gravity assist by raising a bed of the machine above a threshold angle. An operator of the hauling machine manipulates an engine system and a hydraulic system to raise the bed. The operator, utilizing a combination of engine speed and hydraulic valve movement (e.g., hydraulic fluid flow control), controls a speed at which the bed is raised, and consequently, a material discharge rate from the hauling machine. However, the manual manipulation of the engine speed and hydraulic valves is labor intensive and requires significant operator skill.

Many worksites (e.g., mine sites, construction sites, paving sites, etc.) utilize one or more hauling machines to transfer material between locations at the worksite. For example, a hauling machine may deliver ore from a mine to a crushing machine (e.g., a crusher) configured to crush the ore (e.g., crush large rocks into small rocks, gravel, or rock dust). In such an example, the crushing machine receives a first load of material from a first hauling machine, and typically processes the first load while a second hauling machine begins discharging a second load of material into the crushing machine. The operator of the second hauling machine may not be aware of a discharge rate of the second load of material to prevent an overload of the crushing machine. In some examples, modifying the discharge to prevent the overload manually may be difficult due to the complexity of the manual manipulation of the engine and hydraulic systems, resulting in operator fatigue. As such, the crushing machine may be easily overloaded, which may result in crushing machine break downs. Conversely, the operators, not wanting to overload the crushing machine, may discharge material at a slow rate, thereby not utilizing the crushing machine to its maximum capability.

U.S. Pat. No. 6,499,808 (hereinafter, the “'808 reference”) describes an adjustable opening for a dump truck gate to modify a discharge rate material from a bed of a hauling machine. An operator utilizing the system described in the '808 reference may raise a bed of the hauling machine with one set of controls and may adjust the opening in the dump truck gate to modify the discharge rate. However, the '808 reference fails to describe automatically causing material to be discharged at a particular rate. As a result, the '808 reference describes an inefficient, manually intensive system that may lead to operator fatigue and potential damage to equipment.

Example described in the present disclosure are directed toward overcoming the deficiencies noted above.

### SUMMARY

In an aspect of the present disclosure, a system is configured to determine a discharge rate associated with discharging material from a hauling machine. The system is further configured to determine an engine speed and a hydraulic valve position associated with the discharge rate. The system is further configured to cause the hauling machine to discharge material at the discharge rate based at least in part on the engine speed and the hydraulic valve position.

In another aspect of the present disclosure, a method includes determining a discharge rate associated with discharging material from a hauling machine. The method further includes determining at least one of an engine speed or a hydraulic valve position associated with the discharge rate. The method further includes causing the hauling machine to discharge the material at the discharge rate based at least in part on the at least one of the engine speed and the hydraulic valve position.

In yet another aspect of the present disclosure, a hauling machine disposed at a worksite is configured to receive, via a user interface, an input corresponding to a discharge rate associated with discharging material from a bed of the hauling machine. The hauling machine is further configured to determine at least one of an engine speed or a hydraulic valve position associated with the discharge rate. The hauling machine is further configured to cause the material to be discharged from the bed at the discharge rate based at least in part on the at least one of the engine speed and the hydraulic valve position.

### BRIEF DESCRIPTION OF DRAWINGS

FIG. 1 illustrates an example system usable to determine hauling machine discharge rates, in accordance with examples of this disclosure.

FIG. 2 is a flow chart depicting a method for causing a hauling machine to discharge material based on an input corresponding to a discharge rate, in accordance with examples of this disclosure.

FIG. 3 is a flow chart depicting a method for causing a hauling machine to discharge material based on a location associated with the machine, in accordance with examples of this disclosure.

FIG. 4 is a flow chart depicting a method for causing a hauling machine to discharge material based on a capacity of a receiving machine, in accordance with examples of this disclosure.

FIG. 5 is a flow chart depicting a method for causing a bed of a hauling machine to raise to a threshold angle prior to a discharge location, in accordance with examples of this disclosure.

FIG. 6 is a flow chart depicting a method for causing a hauling machine to discharge material at a rate associated with optimizing a performance of a receiving machine.

FIG. 7 is a flow chart depicting a method for causing a bed of a hauling machine to be raised to a threshold angle to reduce on-station time of the hauling machine, in accordance with examples of this disclosure.

FIG. 8 is a flow chart depicting a method for modifying an engine speed or a hydraulic valve rate to discharge material at a discharge rate based on a characteristic of the associated hauling machine, in accordance with examples of this disclosure.

FIG. 9 is an illustration of an example system for implementing the techniques described herein.

### DETAILED DESCRIPTION

Wherever possible, the same reference numbers will be used throughout the present disclosure to refer to the same or like parts.

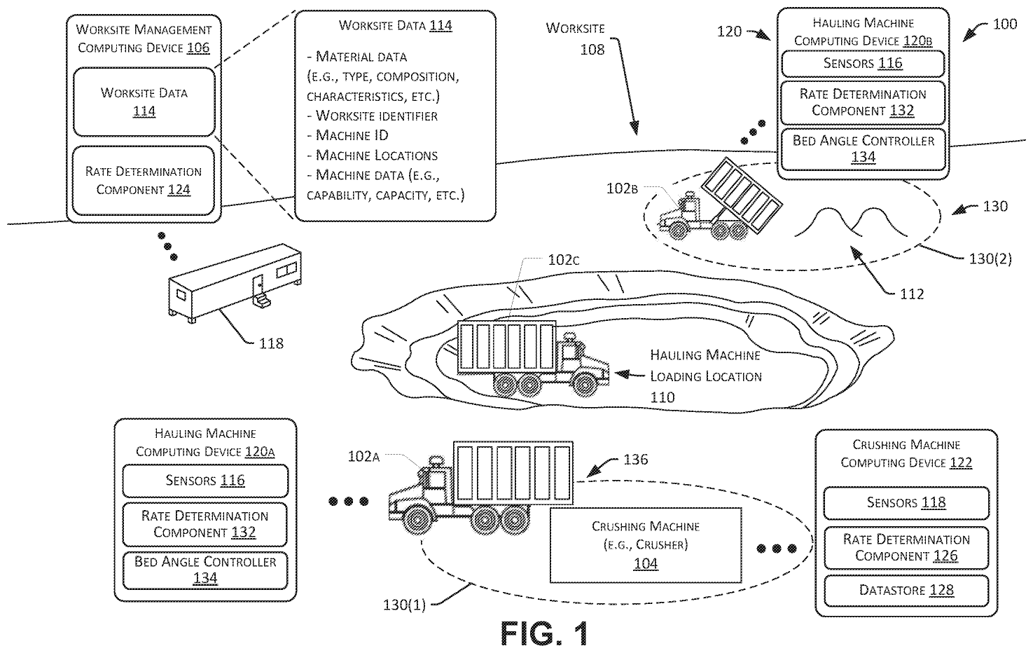

FIG. 1 illustrates an example system 100 usable to determine hauling machine 102 discharge rates. The system 100 includes one or more hauling machines 102 (e.g., haul trucks), one or more crushing machines 104 (e.g., crushers), and/or a worksite management computing device 106 located at a worksite 108. In the illustrative example, the worksite 108 includes a mine site. However, this is not intended to be so limiting, and one skilled in the art understands that the techniques described herein may be usable in any other type of worksite, such as a construction site, refuse and/or recycling site, or the like. Additionally, the techniques described herein are usable in any scenario in which a flow of material discharged from a hauling machine 102 is controlled as a function of an amount of material in a receiving machine and/or an output rate of the receiving machine. While described throughout this disclosure as crushing machine(s) 104, the receiving machine may include any type of machine configured to receive and/or process material.

The hauling machine(s) 102 may be autonomous, semi-autonomous, or manually operated machines. In some examples, the hauling machine(s) 102 are configured to deliver material to the worksite 108, such as from a remote location. In some examples, the hauling machine(s) 102 are configured to move material from a first/source location at the worksite 108 to a second/destination location at the worksite 108. For example, a hauling machine 102(c) travels to hauling machine loading location 110 to be loaded with ore at the worksite 108 (e.g., a mine site). A bed of the hauling machine 102(c) is loaded with the ore at the hauling machine loading location 110, and the hauling machine 102(c) delivers the ore to the crushing machine 104. For another example, the bed of the hauling machine 102(c) is loaded with overburden material (e.g., rock, soil, etc.) at the hauling machine loading location 110, and the hauling machine 102(c) delivers the overburden material to an overburden pile 112.

A hauling machine computing device 120 associated with a hauling machine 102 and/or the worksite management computing device 106 are configured to determine a discharge rate of material from the hauling machine 120 based on one or more factors. The factor(s) may include a type of hauling machine 102 (e.g., bed size, engine size, engine horsepower, hydraulic system, etc.), a location associated with the discharge, a type of material, a capacity of the discharge location and/or a crushing machine 104 associated therewith. In some examples, the hauling machine computing device 120 and/or the worksite management computing device 106 may calculate a capacity of a dump location based on data associated with the location, current capacity, and/or desired rates at the location. In various examples, the capacity of the discharge location may include a capacity to receive material in volume per hour (e.g., cubic feet per hour) and/or mass per hour (tons per hour). As will be discussed below, the capacity of the discharge location may be determined, at least in part on sensor data associated with a receiving machine (e.g., crushing machine 104) and/or other sensor data associated with a discharge location.

In various examples, the worksite management computing device 106 determines various attributes of the material loaded in a hauling machine 102. In some examples, the attributes of the material include a type of material, such as ore, overburden, waste, leach material, and the like. In some examples, the attributes of the material include a composition thereof, such as a percentage of ore, a grade of ore, and the like. In some examples, the attributes of the material include other physical and/or chemical characteristics of the material, such as mineral and/or chemical composition, density, particle volume, cohesiveness (e.g., tendency of material to stick together), hardness, fragmentation, permeability, texture, particle size, and the like. The listed attributes include illustrative examples and are not intended to be limiting; other attributes of the material are contemplated herein. In some examples, the hauling machine computing device 120 and/or the worksite management computing device 106 calculates a discharge rate based on an input of a type of hauling machine, the capacity of the dump location, the density of the material, particle volume, and the cohesiveness of material. In such examples, the hauling machine computing device 120 and/or the worksite management computing device 106 receives the input and determines an angular rate at which to raise a bed of the hauling machine 102 in order to discharge material at the discharge rate. In at least one example, the hauling machine computing device 120 and/or the worksite management computing device 106 determine an initial angular rate based on the type of hauling machine 102 and the capacity of the discharge location. The hauling machine computing device 120 and/or the worksite management computing device 106 then receives attributes of the material, such as the density, volume, and cohesion of the material, and modifies the initial angular rate based on the attributes.

In some examples, the worksite management computing device 106 receives, via a network, information about the type, composition, and/or characteristic(s) of the material from a remote computing device, such as when the hauling machine 102 is loaded with material at a location remote from the worksite 108. In some examples, the remote computing device is associated with an operator of the hauling machine 102, a foreman at the worksite 108, and/or other worksite personnel. In some examples, the remote computing device is associated with a scale at the worksite 108. In such an example, the remote computing device may provide load information associated with a hauling machine 102 located on the scale (e.g., weight, load distribution, etc.).

In some examples, the worksite management computing device 106 determines the attributes of the material based on worksite data 114 associated with the worksite 108. In some examples, the worksite management computing device 106 determines a type of material loaded into a hauling machine 102 based on the worksite data 114. In some examples, the worksite management computing device 106 determines a composition of the material loaded into the hauling machine 102 based on the worksite data 114. In some examples, the worksite management computing device 106 determines a physical and/or chemical composition of the material loaded into the hauling machine 102 based on the worksite data 114. The worksite data 114 includes material data (e.g., the type, composition and/or characteristic(s) of the material at the worksite 108), as well as additional information about the worksite, such as a worksite identifier (unique identifier associated with the worksite 108), machine identifiers (e.g., identifiers associated with hauling machines 102, crushing machine 104, etc.), machine locations (e.g., current locations of various machines operating in the worksite 108), machine data (e.g., size, capability, current load, capacity, operator identifier, timestamp information, etc.). For example, the worksite management computing device 106 accesses worksite data 114 associated with a source location (e.g., location associated with loading the hauling machine) at a particular mine. Based on the worksite data 114, the worksite management computing device 106 determines a type and composition of material extracted from the particular mine proximate the source location and loaded into hauling machines 102 at the source location. Accordingly, the worksite management computing device 106 determines that a hauling machine 102 at the source location is loaded with material of the type and the composition of material.

In various examples, the worksite management computing device 106 determines the machine locations based on sensor data received from one or more sensors 116 associated with the hauling machine and/or one or more sensors 118 associated with a crushing machine 104. In some examples, the worksite management computing device 106 determines machine data based on the sensor data. The sensor(s) may include capacity sensors (e.g., determine an amount of material in a respective machine), location sensors (e.g., global positioning system (GPS), compass, etc.), inertial sensors (e.g., inertial measurement units, accelerometers, magnetometers, gyroscopes, etc.), distance sensors (e.g., laser rangefinder, etc.), lidar sensors, radar sensors, cameras (e.g., RGB, IR, intensity, depth, time of flight, etc.), audio sensors, ultrasonic transducers, sonar sensors, environment sensors (e.g., temperature sensors, humidity sensors, light sensors, pressure sensors, etc.), and the like.

In some examples, the hauling machine computing device 120 processes sensor data from the sensor(s) 116 and sends raw and/or processed sensor data to the worksite management computing device 106. For example, the worksite management computing device 106 receives sensor data from sensor(s) 116 associated with a hauling machine 102(c) and determines that the hauling machine 102(c) is located at the hauling machine loading location 110. In some examples, a crushing machine computing device 122 processes sensor data from the sensor(s) 118 and sends raw and/or processed sensor data to the worksite management computing device 106. For example, the worksite management computing device 106 receives first sensor data at a first time from a capacity sensor 118 associated with the crushing machine 104 and determines that, at the first time, a first amount of material in the crushing machine 104 is below a first threshold amount (e.g., low capacity) and that the crushing machine 104 is ready to receive additional material for processing. The worksite management computing device 106 determines to increase a discharge rate of material from a hauling machine 102. The worksite management computing device 106 receives second sensor data at a second time from the capacity sensor 118 and determines that, at the second time, a second amount of material in the crushing machine is above a second threshold amount. The worksite management computing device 106 determines to decrease the discharge rate of material from the hauling machine based on the second amount of material. The worksite management computing device 106 continues to monitor an amount of material associated with the crushing machine 104 based on the sensor data, and continues to increase and/or decrease the discharge rate from the hauling machine 102 based on the sensor data until receiving an indication from the hauling machine 102 that a transfer of material is complete (e.g., signal that the hauling machine 102 is empty, an amount of material therein is below a threshold amount, etc.)

In various examples, the worksite management computing device 106 determines a location for a hauling machine 102 to discharge a load based on the sensor data captured by the sensor(s) 118 and/or a capability of the associated crushing machine 104. In such examples, the worksite management computing device 106 monitors an amount of material and discharge rate (e.g., capability to process the material) associated with each crushing machine 104 and identifies a particular crushing machine 104 that includes an amount of material and/or discharge rate associated with being ready to receive additional material. For example, a worksite 108 may include three crushing machines. The worksite management computing device 106 receives first sensor data associated with a first crushing machine 104 indicating that the first crushing machine 104 is over capacity (e.g., an amount of material therein exceeds a threshold amount). The worksite management computing device 106 receives second sensor data associated with a second crushing machine 104 indicating that the second crushing machine 104 is also over capacity. The worksite management computing device 106 receives third sensor data associated with a third crushing machine 104 indicating that the third crushing machine is under capacity (e.g., an amount of material therein is less than a threshold amount). Based on a determination that the first and second crushing machines 104 are over capacity and the third crushing machine is under capacity, as indicated by the third sensor data, the worksite management computing device 106 determines a location associated with the third crushing machine 104 for the hauling machine 102 to discharge the load of material.

In some examples, the worksite management computing device 106 determines the location for the hauling machine 102 to discharge the load based on the material data (e.g., type, composition, characteristics, etc.) associated with the load (e.g., material loaded in the hauling machine 102. In such examples, the worksite management computing device 106 accesses the worksite data 114 to determine the material data associated with material loaded into a hauling machine and determines a discharge location 130 based on the material data. For example, a worksite management computing device 106 determines, based on worksite data 114, that a hauling machine is loaded with leach material. Based on the determination that the load includes leach material, the worksite management computing device 106 determines a location associated with a leach field for the hauling machine 102 to discharge the load. For another example, a worksite management computing device 106 determines, based on worksite data 114, that a hauling machine is loaded with overburden material. Based on the determination that the load includes overburden material, the worksite management computing device 106 sends an instruction to the hauling machine computing device 120 for the hauling machine 102 to discharge the load at the overburden pile 112.

In some examples, the worksite management computing device 106 sends an instruction to the hauling machine 102 to travel to the location to discharge the load. For example, the worksite management computing device 106 determines that the hauling machine 102(c) was loaded with ore at the hauling machine loading location 110. The worksite management computing device 106 also determines that the crushing machine 104 is ready to receive additional material for processing. The worksite management computing device 106 may send an instruction to a hauling machine computing device 120 associated with the hauling machine 102(c) (not illustrated) to deliver the ore to the crushing machine 104. In some examples, the instruction may be presented (e.g., surfaced) on a display for viewing by an operator. In such examples, the operator may view the instruction and operate the hauling machine 102(c) to the designated crushing machine 104. In examples in which the hauling machine 102(c) is autonomous, the instruction may cause the hauling machine computing device 120 to control the hauling machine 102(c) to a location associated with the crushing machine 104.

In various examples, the worksite management computing device 106 includes a rate determination component 124 configured to determine a discharge rate for the hauling machine 102 to discharge material. As discussed above, the discharge rate is determined based on a discharging location 130 and/or a capacity of the discharge location to receive material, as well as attributes of the material being discharged. The rate determination component 124 determines a discharge location 130, such as a crushing machine 104, a current load in the crushing machine 104, a capability of the crushing machine to process the material to be discharged therein, such as based on the attributes of the material. In some examples, the rate determination component 124 determines an angular rate at which to raise a bed to achieve the discharge rate. In some examples, the angular rate is determined based on the density of material, particle volume, and cohesiveness of the material. In such examples, the attributes of the material, such as the tendency of the material to stick together and discharge in clumps, effects the angular rate determination. In some examples, the rate determination component determines the discharge rate and/or associated angular rate based on the discharge location and a type of material to be discharged. For example, the rate determination component 124 determines that a hauling machine 102(b) is loaded with overburden material to be discharged into the overburden pile 112. Based in part on the type of material (overburden), the rate determination component 124 determines that the material should be discharged at a maximum (e.g., fast) rate, thereby minimizing a time on-station at the overburden pile 112.

In some examples, the rate determination component 124 may determine the discharge rate based on a capability of a crushing machine 104 receiving a load. In some examples, the capability of the crushing machine 104 may include a speed (e.g., throughput or rate) at which the crushing machine 104 may process materials of types, composition, and/or characteristics. For example, a first crushing machine 104 is configured to process limestone at a rate of approximately 40 tons per hour. Based on the capability of the crushing machine 104, the rate determination component 124 may determine that a hauling machine 102(a) may discharge a load of limestone at a rate of approximately 40 tons per hour. For another example, a second crushing machine 104 is configured to process large rocks at a rate of approximately 10 tons per hour. Based on this relatively slower processing rate, the rate determination component 124 may determine that a hauling machine 102(a) may discharge a load of large rocks at the rate of approximately 10 tons per hour, such as to not exceed the capability of the crushing machine 104.

In some examples, the rate determination component 124 determines the discharge rate based on a capacity of the crushing machine 104 receiving the load. In such examples, the discharge rate is based on sensor data received from the sensor(s) 118 associated with the crushing machine. In some examples, the crushing machine computing device 122 receives sensor data comprising a current capacity of the crushing machine 104 from the sensor(s) 118. In some examples, the crushing machine computing device 122 sends the current capacity to the worksite management computing device 106 in real-time or near real-time (e.g., within seconds of measurement). In such examples, the rate determination component 124 determines the discharge rate for a hauling machine 102, such as hauling machine 102(A) based on the current capacity. For example, the worksite management computing device 106 receives sensor data from the crushing machine computing device 122 indicating that the current capacity of the crushing machine 104 is below a threshold capacity. Based on the current capacity, the rate determination component 124 determines to increase a discharge rate of material from the hauling machine 102(A) into the crushing machine 104.

In some examples, the crushing machine computing device 122 includes a rate determination component 126, such as rate determination component 124, configured to determine the discharge rate based on a current capacity and/or capability of the crushing machine 104. In such examples, the crushing machine computing device 122 receives the sensor data comprising the current capacity of the crushing machine 104 from the sensor(s) 118 and determines the discharge rate. For example, the crushing machine computing device 122 determines that a current capacity of the crushing machine is at 80% and that if the hauling machine 102(a) continues to discharge material at a current rate, an amount of material in the crushing machine will exceed a threshold amount at a time in the future (e.g., discharge rate exceeds processing rate associated with the crushing machine 104). Based on the current capacity, the rate determination component 126 may determine that a slower discharge rate (e.g., 30 tons per hour less) will avoid overloading the crushing machine 104. Though this is merely an example and is not intended to be limiting.

In some examples, the rate determination component 126 determines the discharge rate for a current load based on a previous discharge rate and/or load previously discharged into the crushing machine 104. For example, the rate determination component 126 determines that a hauling machine 102 at a first discharged a load of 85% ore into the crushing machine 104 at a particular rate that was efficient for the crushing machine 104 (e.g., maintains a level of material in the crushing machine 104 above a minimum threshold and below a maximum threshold, such as to not under load or overload the crushing machine 104). The rate determination component 126, such as based on worksite data 114 received from the worksite management computing device 106, determines that the hauling machine 102(A) includes 85% ore. Based in part on the efficiency of processing the 85% ore at the particular rate, the rate determination component 126 determines that the hauling machine 102(A) should discharge the material at the particular rate. The rate determination component 126 sends the discharge rate data (e.g., the particular rate) to the worksite management computing device 106 and/or directly to the hauling machine computing device 120(A).

In some examples, the crushing machine computing device 122 stores data associated with various types of material, such as previous discharge rate at which a specific quantity of material was previously discharged into the crushing machine 104 in a datastore 128. In some examples, the rate determination component 126 accesses the data in the datastore 128 to determine the discharge rate for a hauling machine 102. In various examples, the crushing machine computing device 122 sends the data associated with previous discharge rates and/or loads previously discharged into the crushing machine 104 to the worksite management computing device 106. In some examples, the worksite management computing device 106 stores the data. In some examples, the rate determination component 124 accesses the data to determine a discharge rate for a hauling machine 102, such as that described above with regard to rate determination component 126.

In various examples, the rate determination component 124 determines a discharge rate for a hauling machine 102 based on a discharge location 130 associated therewith. The discharge location 130 includes a crushing machine 104 or other receiving machine (e.g., machine configured to receive a load from a hauling machine 102), an overburden pile, a leech field, a stock pile, or the like. For example, a discharge location 130(1) is associated with the overburden pile 112. Based on a determination that the hauling machine 102(B) is proximate (e.g., within a threshold distance of, is nearby) the discharge location 130(2), the rate determination component 124 determines a discharge rate of maximum to unload the bed as quickly as possible.

In the illustrative example, the discharge location 130 includes an area associated with a particular discharge location 130. In at least one example, the discharge location 130 includes a geo-fenced area. In such an example, the area includes a pre-defined area, which may be uniquely shaped, around a discharge location 130. In some examples, the area is defined by a radius (e.g., 100 feet, 30 meters, etc.) around a particular discharge location 130. In various examples, the rate determination component 124 determines that the hauling machine 102 is in the area associated with the particular discharge location 130 and determines the discharge rate based on the area. For example, the worksite management computing device 106 receives location data from one or more sensors 116 associated with a hauling machine 102(A) and determines that the hauling machine 102(A) is inside the geo-fenced area associated with the discharge location 130(1). Based on the discharge location 130(1) (and/or the capacity and/or capability of the crushing machine 104 and/or other factors), the rate determination component 124 determines a fuel-efficient discharge rate (e.g., discharge rate determined to maximize material discharged/fuel burned).

The fuel-efficient discharge rate includes an angular rate at which the bed is raised determined to maximize fuel efficiency. In various examples, the rate determination component 124 determines an optimal operating speed of an engine and/or load on the engine. The optimal operating engine speed and/or engine load may include a stored value, such as that stored in a memory of the worksite management computing device 106. In some examples, the optimal operating engine speed and/or engine load may be configured to be an efficient operating point associated with minimal fuel burn. In some examples, the optimal operating engine speed and/or engine load is configured to increase a life of components of the hauling machine (e.g., engine components, hydraulic components, etc.) In various examples, the rate determination component 124 is configured to cause the engine to set the optimal operating engine speed and/or engine load. In such examples, a bed angle controller 134 of the hauling machine 102 drives the engine to the optimal operating speed and/or load in order to discharge material at a fuel-efficient rate.

In various examples, the hauling machine computing device 120 includes a rate determination component 132 configured to determine a discharge rate. In various examples, the rate determination component 132 receives data, such as sensor data, directly from the crushing machine computing device 122. In such an example, the rate determination component 132 determines a discharge rate based on the data. In some examples, the rate determination component 132 determines that the hauling machine 102 is proximate the discharge location 130, such as based on location data from one or more sensors 116. In such examples, the rate determination component 132 determines the discharge rate based on the discharge location 130.

In various examples, the rate determination component 132 receives worksite data 114 from the worksite management computing device 106 and determines the discharge rate based at least in part on the worksite data 114. In some examples, the rate determination component 132 functions similarly to the rate determination component 124 described above. For example, the hauling machine computing device 120(A) receives worksite data 114 including capability data associated with the crushing machine 104. Based on the capability data the rate determination component 132 determines that a discharge rate that will optimize the performance of the crushing machine 104 (e.g., not overload, load too slowly). For another example, the worksite management computing device 106 sends the hauling machine computing device 120(B) material data associated with the load (e.g., that the machine is loaded with overburden material. The rate determination component 132 of the hauling machine computing device 120(B) determines that the material should be discharged at a maximum rate.

In various examples, the rate determination component 132 determines the discharge rate based on input received via a user interface, such as by an operator of the hauling machine 102. In some examples, the input may include a selection, via a push button, rotary knob, or other input device, to set a particular discharge rate. For example, a user interface in a cabin of a hauling machine 102(a) may include a slow button associated with discharging material slowly (e.g., 100 pounds per minute, etc.), a fuel-efficient button associated with maximizing fuel efficiency (e.g., maximum discharge for minimum fuel burn), and a fast button associated with discharging material at a maximum rate (e.g., 500 pounds per minute). Though the rates are merely for illustrative purposes and are not intended to be limiting. In some examples, the input received via the user interface may include an instruction to establish a discharge rate, such as that determined by the rate determination component 132 and/or received from another computing device (e.g., crushing machine computing device 122 and/or worksite management computing device 106).

In various examples, the rate determination component 132 determines a maximum allowable rate associated with a discharge of material. The maximum allowable rate is based on a particular discharge location 130 associated with the discharge, a crushing machine 104 associated with a discharge location 130, material data, and the like. For example, a crushing machine may process material at 100 pounds per minute. The maximum allowable rate associated with discharge of material into the crushing machine may be 100 pounds per minute. In various examples, an input received via the user interface exceeds the maximum allowable rate. In such examples, the rate determination component 132 receives the input and limits the discharge rate to the maximum allowable rate. For example, a crushing machine 104 receiving a load from a hauling machine 102 may have a maximum allowable discharge rate of 50 pounds per minute. An operator of the hauling machine 102 may input an instruction via a user interface for the hauling machine 102 to discharge material at 100 pounds per minute. The rate determination component 132 receives the input via the user interface and sets the maximum allowable rate associated with the crushing machine 104, such as to avoid overburdening the crushing machine 104.

In various examples, the rate determination component 132 determines the discharge rate based on a fuel quantity associated with the hauling machine 102. In some examples, the rate determination component 132 determines that the fuel quantity is less than a threshold quantity and automatically sets a discharge rate that results in a minimal amount of fuel burned to discharge the material. The discharge rate associated with the minimal amount of fuel may include a minimum discharge rate or a fuel-efficient discharge rate. In some examples, the rate determination component 132 may provide an indication of automatically setting the discharge rate based on the fuel quantity to an operator of the hauling machine 102, such as via a user interface. In some examples, the rate determination component 132 may send the indication of automatically setting the discharge rate to the worksite management computing device 106.

In various examples, the rate determination component 132 sends the discharge rate to a bed angle controller 134 of the hauling machine computing device 120. Responsive to receiving the discharge rate, the bed angle controller 134 automatically modifies an angle of the bed of the associated hauling machine 102, such as to discharge material at the discharge rate. The angle of the bed includes an elevation from a horizontal axis associated with the hauling machine and/or a stored position of the bed (e.g., seated position, rest, down, etc.) to an axis associated with a bottom surface of the bed. The rate of change of the angle of the bed may include a rate at which the bottom surface of the bed lifts relative to the horizontal axis. In various examples, the bed angle controller 134 may modify the angular rate at which the bed is raised to maintain the discharge rate. For example, a bed angle controller 134 sets an initial angular rate of 5 degrees per minute to discharge material at a discharge rate out of a full bed. As the amount of material decreases in the bed, the bed angle controller 134 may increase the angular rate to 10 degrees per minute to maintain the discharge rate. As discussed above, the bed angle controller may raise the bed at a first angular rate to a threshold angle and a second angular rate associated with the discharge rate above the threshold angle, such as to reduce a total amount of time associated with the discharge.

In some examples, the discharge rate of material from the bed of the hauling machine 102 is controlled based on the angle of the bed and/or the angular rate of the bed. In some examples, the bed angle controller 134 receives the discharge rate from the rate determination component 132, rate determination component 124 and/or rate determination component 126.

In various examples, the bed angle controller 134 determines an engine speed and/or a hydraulic valve position associated with the discharge rate (associated angular rate). In some examples, the bed angle controller 134 determines the engine speed and/or the hydraulic valve position based on one or more characteristics of the hauling machine 102. The characteristic(s) include engine size, horsepower, hydraulic reservoir capacity, hydraulic system size, hydraulic system components (e.g., valve size, robustness, etc.), and the like. In some examples, the characteristic(s) may be indicative of a weak component (e.g., less robust component) and/or a strong component (e.g., more robust component) associated with hauling machine bed operation. For example, a hauling machine computing device 120(A) associated with a hauling machine 102(A) including a small engine and a robust hydraulic system receives an input to discharge material at a maximum discharge rate. The bed angle controller 134 associated with the hauling machine computing device 120(A) determines to set the engine at a medium speed and a hydraulic valve at a position to cause the hydraulic system to carry the burden of lifting the bed. In such an example, the bed angle controller 134 relies more heavily on the robust hydraulic system, while preserving the operational life of the small engine. For another example, a hauling machine computing device 120(B) associated with a hauling machine 102(B) including a large engine and a hydraulic system with a weak component receives an input to discharge material at a maximum discharge rate, such as at the overburden pile 112. The bed angle controller 134 associated with the hauling machine computing device 120(B) determines to set an engine speed to maximum to cause the engine to carry the burden of lifting the bed. In such an example, the bed angle controller 134 relies heavily on the large engine to lift the bed, while preserving the operational life of a weaker hydraulic system.

In various examples, hauling machine computing device 120 determines that the hauling machine 102 is within a threshold distance (e.g., 100 feet, 50 feet, 20 yards, 15 meters, etc.) of a discharge location 130. In some examples, the threshold distance may be determined based on sensor data from sensor(s) 116, such as proximity sensors, laser rangefinders, and the like. In some examples, the hauling machine computing device 120 determines that the hauling machine is within the previously defined area associated with a discharge location, such as a geo-fenced area. In some examples, the hauling machine computing device 120 determines that the hauling machine 102 includes a trajectory associated with discharging a load (e.g., trajectory associated with approaching a discharge location 130). In some examples, the trajectory associated with discharging the load includes a reversing trajectory. In various examples, based on a determination that the hauling machine 102 is within a threshold distance to the discharge location 130 and/or is on a reversing trajectory (e.g., transmission in reverse, traveling toward the discharge location 130), the hauling machine computing device 120 sends a command to the bed angle controller 134 to begin raising the bed to a threshold angle (e.g., 15 degrees, 20 degrees). The threshold angle includes an angle at which material will not be discharged from the bed of the hauling machine 102. In some examples, the bed angle controller 134 raises the bed to the threshold angle at a rate that is faster than the angular rate associated with the discharge rate. In such examples, the bed angle controller 134 may expedite the discharge of material by positioning the bed at an angle close to a discharge angle at a fast rate, then slowing the angular rate above the threshold angle to discharge the material at the desired rate. In some examples, raising the bed to the threshold angle prior to arrival at a discharge location 130 may reduce a total time associated with a discharge of material at the discharge location 130. The reduction in the total time associated with the discharge of material from each hauling machine 102 discharging a load increases a number of hauling machines 102 that may discharge loads over a period of time (e.g., throughout a workday) and thus may increase overall productivity and efficiency at the worksite 108.

In various examples, the operator of the hauling machine 102 inputs the command, such as via the user interface, to begin raising the bed to the threshold angle. In some examples, responsive to receiving the command (from the operator or the hauling machine computing device 120), the bed angle controller 134 causes the bed to raise to the threshold angle, thereby reducing the total time associated with discharging a load from the hauling machine 102. For example, as the hauling machine 102(A) approaches the crushing machine 104 in reverse, the bed angle controller 134 may raise the bed to the threshold angle.

In various examples, the bed angle controller 134 holds the bed at the threshold angle until it receives an indication that the hauling machine 102 is established in a discharging position 136. The bed angle controller 134 may hold the bed at the threshold angle to prevent an inadvertent discharge of material. In some examples, the hauling machine computing device 120 determines the discharging position 136 based on location data and/or proximity data determined based on the sensor(s) 116. Once established in the discharging position 136, the bed angle controller 134 further raises the bed to cause the hauling machine 102 to discharge material at the discharge rate into the crushing machine 104.

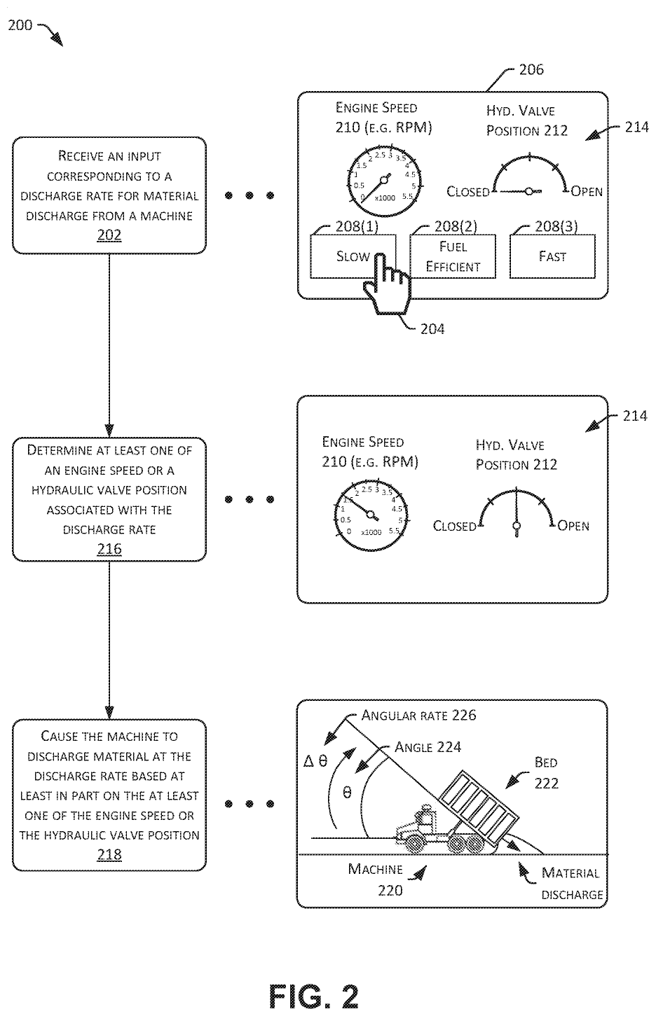

FIGS. 2-8 illustrate example processes in accordance with embodiments of the disclosure. These processes are illustrated as logical flow graphs, each operation of which represents a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes.

FIG. 2 includes a flow chart depicting a process 200 for causing a hauling machine to discharge material based on an input corresponding to a discharge rate, in accordance with examples of this disclosure. As discussed above, the discharge rate includes a rate at which material is discharged from a bed of the hauling machine. In some examples, the discharge rate may be determined based on an angle of the bed and/or a rate of change of the angle of the bed. The angle of the bed and/or the rate of change of the angle may cause the material to discharge due to the effects of gravity. For example, a first angle of the bed at 30 degrees results in a first discharge rate of 30 pounds per minute and a second angle of the bed at 35 degrees results in a second discharge rate of 50 pounds per minute.

At operation 202, a hauling machine computing device, such as hauling machine computing device 120, receives an input corresponding to a discharge rate for material discharge from a machine. The machine includes a hauling machine (e.g., a haul truck, or other machine configured to carry and discharge a load of material).

In some examples, the input is received from a remote computing device, such as from a worksite management computing device (e.g., device 106) and/or crushing machine computing device (e.g., device 122). In such examples, the hauling machine computing device may process the input and determine the discharge rate provided by the remote computing device. In the illustrative example, an operator 204 of the hauling machine provides the input via a user interface 206. The user interface 206 provides a means by which the operator 204 controls the discharge of material (e.g., by manipulating the angle of the bed).

In the illustrative example, the user interface 206 includes three discharge rates, each with a corresponding selectable option 208. For example, the user interface 206 includes a first selectable option 208(1), a second selectable option 208(2), and a third selectable option 208(3). In the illustrative example, the first selectable option 208(1) corresponds to a slow discharge rate (e.g., 1-10 tons per minute), the second selectable option 208(2) corresponds to a fuel-efficient discharge rate (e.g., optimized material discharged per gallon of fuel burned by the hauling machine), and the third selectable option 208(3) includes a fast discharge rate (e.g., 15-40 tons per minute). In other examples, the user interface 206 includes other selectable options 208. In yet other examples, the user interface 206 includes a greater or lesser number of selectable options. For example, the user interface 206 may include a selection for a normal discharge rate (e.g., an average speed for discharging material) and a slow discharge rate. In some examples, the discharge rate and/or selectable options 208 are determined based on a storage capacity of the hauling machine. In some examples, the user interface 206 includes a rotary knob via which the operator 204 may gradually increase or decrease a discharge rate (e.g., change a bed angle and/or modify a rate of change of the bed angle).

As illustrated, the user interface 206 includes the fuel-efficient selectable option 208(2). The fuel-efficient selectable option 208(2) includes a discharge rate corresponding to an engine speed 210 and/or a hydraulic valve position 212 that results in a maximized discharge of material per gallon of fuel burned. The hauling machine computing device or other computing device (e.g., worksite management computing device, etc.) determines the discharge rate associated with the fuel-efficient selectable option 208(2) based in part on a discharge history associated with the machine and/or other hauling machines of a same or similar type (e.g., same or similar engine size, same or similar hydraulic system, etc.). In such example, the hauling machine computing device or other computing device compares discharge rates, times associated with discharging a load, fuel burned during the discharge, and the like, to determine the maximized discharge of material per gallon of fuel burned.

In various examples, the hauling machine computing device or other computing device monitors an amount of fuel burned per load discharged. The fuel burn may be attributable, at least in part to the engine increase in revolutions per minute, such as to drive the hydraulic system and raise the bed of the hauling machine. Over time, the hauling machine computing device or other computing device determines a discharge rate associated with a most fuel-efficient discharge of material. In some examples, the hauling machine computing device or other computing device determines the engine speed and/or time associated with the discharge to determine the most fuel-efficient discharge of material.

In the illustrative example, the user interface 206 includes a display 214 comprising the engine speed 210 and the hydraulic valve position 212. In other examples, the user interface 206 includes additional and/or alternative instrumentation associated with machine component performance. For example, the user interface 206 includes a hydraulic fluid reservoir quantity, to permit the operator 204 to monitor a level of hydraulic fluid in the reservoir.

At operation 216, the hauling machine computing device determines at least one of an engine speed 210 or a hydraulic valve position 212 associated with the discharge rate. The engine speed 210 and the hydraulic valve position 212 correspond to lifting a bed of the machine to an angle and/or at a rate of angle change that results in the discharge rate of material from the bed.

In some examples, the hauling machine computing device determines the engine speed 210 and/or the hydraulic valve position 212 based on one or more characteristics associated with the machine. The characteristic(s) include engine size, horsepower, hydraulic reservoir capacity, hydraulic system size, hydraulic system components (e.g., valve size, robustness, etc.), and the like. In some examples, the characteristic(s) may be indicative of a weak point (e.g., a least robust component) and/or a strong point (e.g., a most robust component) associated with hauling machine bed operation. For example, the machine includes a small engine and a robust hydraulic system. The associated hauling machine computing device receives an input corresponding to the fast selectable option 208(3) (e.g., maximum discharge rate). The hauling machine computing device determines to set the engine speed at 2,000 RPM (e.g., a medium speed) and a hydraulic valve position 212 at full open, so that the hydraulic system carries the burden of lifting the bed. In such an example, hauling machine computing device relies more heavily on the robust hydraulic system, while preserving the operational life of the small engine.

At operation 218, the hauling machine computing device causes the machine 220 to discharge material at the discharge rate based at least in part on the at least one of the engine speed 210 or the hydraulic valve position 212. As discussed above, the engine speed 210 and the hydraulic valve position 212 combined result in a bed 222 lifting to an angle 224 and/or at an angular speed 226 that corresponds to the discharge rate.

The hauling machine computing device automatically determines the engine speed and/or hydraulic valve position to automatically cause the machine to discharge the material at the discharge rate based on the operator 204 input. As discussed above, traditionally, the discharge of material and/or a discharge rate control is a manually intensive process that requires a significant amount of skill for the operator 204 to determine an engine speed 210 and hydraulic valve position 212 associated with a desired discharge rate. The techniques described herein improve upon the previous systems at least due to the automation of such systems. As such, the techniques described herein automate a previously manual process, thereby reducing operator 204 workload.

Furthermore, the techniques described herein include an option to discharge material at a fuel-efficient rate. Traditional systems do not monitor fuel burn rates associated with discharging material. Accordingly, the techniques described herein further improve upon traditional systems by providing a means by which hauling machines may increase fuel efficiency and decrease an environmental impact associated with operation.

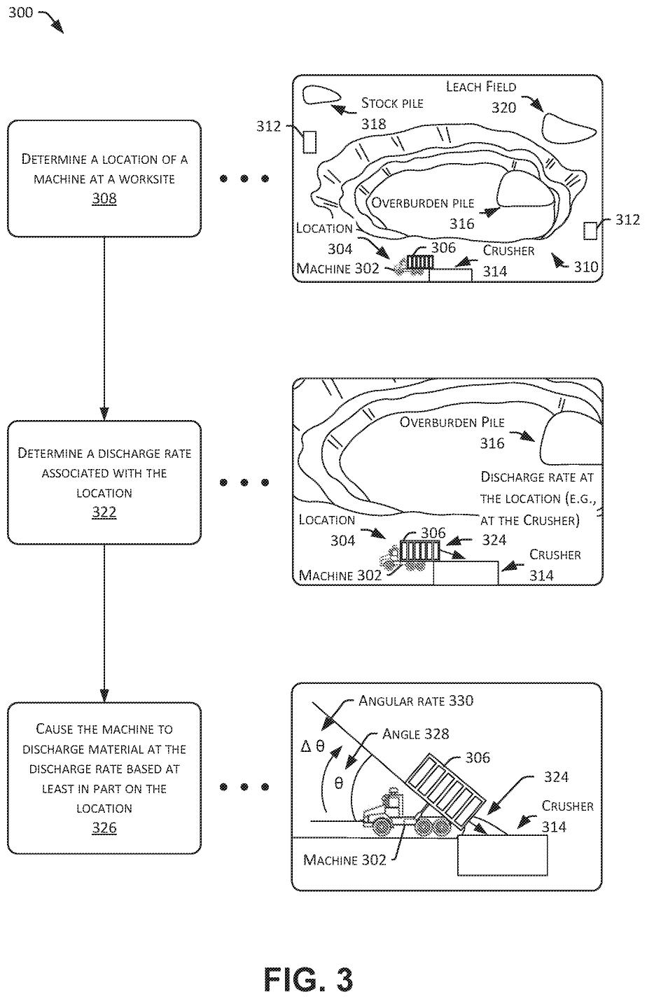

FIG. 3 includes a flow chart depicting a process 300 for causing a machine 302 to discharge material based on a location 304 associated with the machine 302, in accordance with examples of this disclosure. The machine 302 includes a hauling machine (e.g., haul truck) configured to carry a load of material in a bed 306 and discharge the material, such as by raising the bed 306.

In various examples, the process 300 is performed by a processor of a computing device associated with the machine 302, such as hauling machine computing device 120. In some examples, the process 300 is performed by a processor of a worksite management computing device, such as worksite management computing device 106. In such examples, the worksite management computing device may be configured to communicate with the computing device associated with the machine and/or other computing devices associated with the worksite, such as a computing device associated with the crushing machine 314. In some examples, the worksite management computing device may send instructions to the computing device of the machine to cause the machine to perform actions, such as to travel to a particular location, discharge material at a particular discharge rate, and the like.

At operation 308, a processor determines a location 304 of a machine 302 at a worksite 310, such as worksite 108. The processor may include a processor of a hauling machine computing device, such as hauling machine computing device 120, or a processor of a worksite management computing device, such as worksite management computing device 106.

In various examples, the location 304 of the machine 302 is determined based on one or more sensors associated with the machine 302. In some examples, the sensor(s) include location sensors (e.g., GPS, compass, etc.) and/or inertial sensors (e.g., inertial measurement units, accelerometers, magnetometers, gyroscopes, etc.). For example, the processor may receive sensor data from a GPS sensor and may determine the location 304 of the machine 302 based on the GPS data.

In some examples, the location 304 of the machine 302 is determined based on one or more other sensors 312, such as those mounted at the worksite 310 and/or mounted on other machines, such as a crushing machine 314 (e.g., labeled crusher 314 for brevity in the illustration). In such examples, the other sensor(s) 312 include cameras, lidar, distance sensors, motion sensors, Bluetooth devices, and/or other sensor(s) 312 configured to sense a presence of the machine 302 and/or identify the machine 302, such as based on a unique identifier associated therewith.

In various examples, the location 304 may be associated with a discharge location, such as discharge location 130. The discharge locations illustrated in FIG. 3 include the crushing machine 314, an overburden pile 316, a stock pile 318, and a leach field 320. As discussed above, the crushing machine 314, the overburden pile 316, the stock pile 318, and the leach field 320 may each have associated therewith an area (e.g., geo-fenced area, area defined by a radius from a center of the discharge location, etc.). In some examples, the processor may determine that the location 304 of the machine 302 is associated with an area hosting at least one of the crushing machine 314, the overburden pile 316, the stock pile 318, or the leach field 320.

At operation 322, the processor determines a discharge rate 324 associated with the location 304. The discharge rate 324 includes a rate of material discharge from the bed 306 of the machine 302. In some examples, the processor determines that the location 304 is within a threshold distance from (e.g., is proximate to) the crushing machine 314, the overburden pile 316, the stock pile 318, or the leach field 320. In some examples, the processor determines that the location 304 is within an area associated with the crushing machine 314, the overburden pile 316, the stock pile 318, or the leach field 320. In such examples, the discharge rate 324 is determined based on the respective discharge location (e.g., the crusher 314, the overburden pile 316, the stock pile 318, or the leach field 320).

In various examples, each discharge location has associated therewith a discharge rate 324. For example, the crushing machine 314 has a first discharge rate 324 associated therewith, the first discharge rate 324 including a slow discharge rate, to provide the crushing machine 314 time to process the discharged material so as to not exceed the capacity of the crushing machine 314. The overburden pile 316 has a second discharge rate 324 associated therewith, including a fast discharge rate 324, to minimize a total time that the machine 302 is located at the overburden pile 316.

At operation 326, the processor causes the machine to discharge material at the discharge rate based at least in part on the location 304. In various examples, the processor determines an engine speed and/or a hydraulic valve position associated with the discharge rate. In such examples, the processor sets the engine speed and/or hydraulic valve position to raise the bed to an angle 328 and/or at an angular rate 330 associated with the discharge rate.

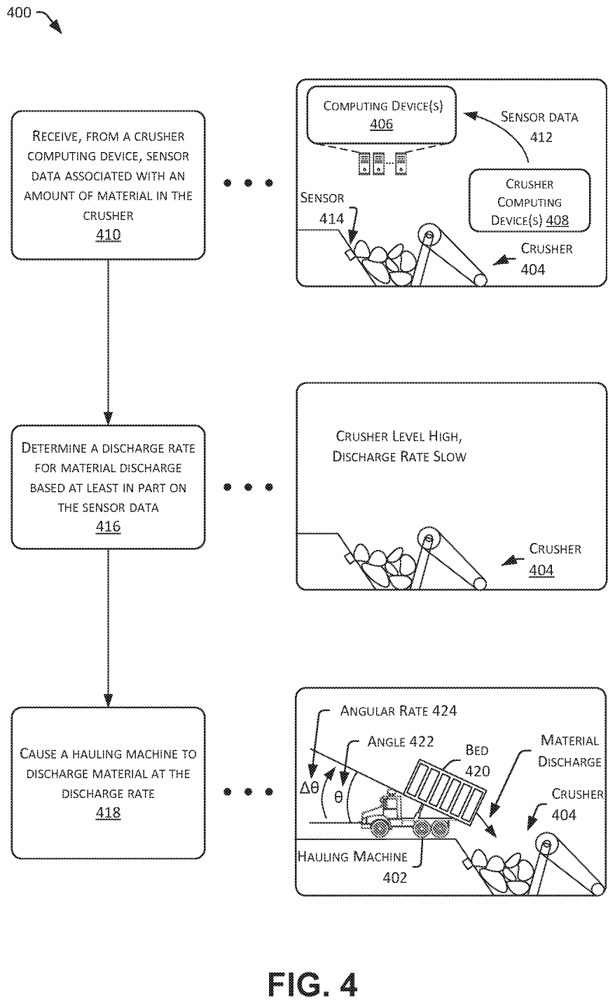

FIG. 4 includes a flow chart depicting a process 400 for causing a hauling machine 402 to discharge material based on a capacity of a receiving machine, in accordance with examples of this disclosure. In the illustrative example, the receiving machine includes a crushing machine 404 (labeled as crusher 404 for brevity in the illustration), such as crushing machine 104. In other examples, the crushing machine 404 includes any other type of machine configured to receive and/or process material discharged from a hauling machine 402.

The process 400 is performed by one or more computing devices 406 (e.g., one or more processors associated therewith). In some examples, the computing device(s) 406 are associated with the hauling machine 402, such as hauling machine computing device 120. In some examples, the computing device(s) 406 include a worksite management computing device, such as worksite management computing device 106. In such examples, the worksite management computing device may be configured to communicate with the computing device associated with the hauling machine 402 and a crushing machine computing device 408 (labeled as crusher computing device 408 for brevity) associated with the receiving machine 404, such as crushing machine computing device 122.

At operation 410, the computing device(s) 406 receive, from a crushing machine computing device 408, sensor data 412 associated with an amount of material in the receiving machine 404. In some examples, the receiving machine 404 includes one or more sensors 414 configured to determine the amount of material in the crushing machine 404 The sensor(s) 414 provide raw and/or processed sensor data 412 to the crushing machine computing device(s) 408, which is then provided to the computing device(s) 406. In some examples, the crushing machine computing device(s) 408 processes the sensor data 412 prior to sending the sensor data 412 to the computing device(s) 406. In some examples, the crushing machine computing device(s) 408 store the sensor data 412 in a datastore associated therewith.

At operation 416, the computing device(s) 406 determine a discharge rate for material discharge based at least in part on the sensor data 412. In some examples, the computing device(s) 406 determine the discharge rate based on a current level of material in the receiving machine 404. For example, based on determination that a level in the receiving machine 404 is high, the computing device(s) 406 determine that a slow discharge rate should be established, in order to not overload the receiving machine 404. For another example, based on a determination that a level in the crushing machine 404 is low, the computing device(s) 406 determine that the crushing machine 404 is capable of receiving material a fast discharge rate.

In some examples, the computing device(s) 406 determines the discharge rate based on a capability of the receiving machine 404. In such examples, the discharge rate is based on the amount of material the crushing machine 404 can process (e.g., tons per hour, etc.). In some examples, the capability of the crushing machine 404 is determined based on a type of machine associated with the crusher and/or specifications associated therewith. For example, a j aw crusher is configured to process material at a first rate and a gyratory crusher is configured to process material at a second rate.

In various examples, the capability of the crushing machine 404 is determined based on material data (e.g., a type, composition, and/or characteristics) associated with the material to be processed. In such examples, the amount of material that the crushing machine 404 can process over a time period (e.g., tons per hour) is based in part on a type, composition, and/or characteristic associated with the material. For example, a crushing machine 404 processes 10 tons of large rocks per hour and 20 tons of medium sized rocks per hour.

In various examples, the computing device(s) 406 determine the discharge rate to optimize performance of the receiving machine 404. In such examples, the discharge rate results in the crushing machine 404 maintaining a level of material therein that does not overload or underload the receiving machine 404. In various examples, the discharge rate is associated with an optimal output of the receiving machine 404.

At operation 418, the computing device(s) 406 cause a hauling machine to discharge material at the discharge rate. In various examples, the computing device(s) 406 determine an engine speed and/or a hydraulic valve position associated with the discharge rate. In such examples, the computing device(s) 406 set the engine speed and/or hydraulic valve position to raise a bed 420 to an angle 422 and/or at an angular rate 424 associated with the discharge rate.

In examples in which the computing device(s) 406 include the worksite management computing devices, the computing device(s) 406 may send an instruction to the hauling machine computing device to discharge material at the discharge rate. In some examples, responsive to receiving the instruction to discharge material at the discharge rate, the hauling machine computing device may determine the engine speed and/or hydraulic valve position associated therewith. In some examples, the instruction includes the engine speed and/or hydraulic valve position associated with the discharge rate. In such examples, responsive to receiving the instruction, the hauling machine computing device establishes the engine speed and hydraulic valve position associated with the discharge rate.

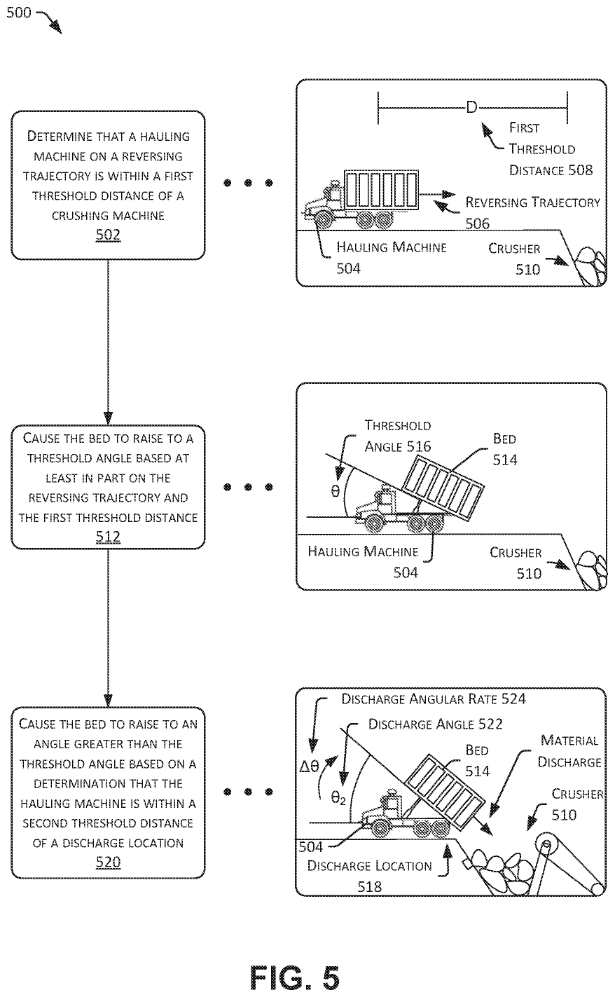

FIG. 5 includes a flow chart depicting a process 500 for causing a bed of a hauling machine to raise to a threshold angle prior to a discharge location. The process 600 may be performed by a processor associated with a hauling machine computing device, such as hauling machine computing device 120, and/or a worksite management computing device, such as worksite management computing device 106.

At operation 502, the processor determines that a hauling machine 504 on a reversing trajectory 506 is within a first threshold distance 508 of a crushing machine 510 (illustrated as “crusher 510”). In various examples, the first threshold distance 508 may be determined based on sensor data captured by one or more sensors of the hauling machine 504 and/or the crushing machine 510. For example, the sensor data may include data captured by a proximity sensor associated with the hauling machine 504 and/or the crushing machine 510.

In various examples, the processor determines that the hauling machine 504 is traveling on a reversing trajectory 506 based on a transmission setting associated therewith. For example, a “reverse” transmission setting may indicate that the hauling machine 504 is traveling on the reversing trajectory 506. In some examples, the processor determines that the hauling machine 504 is traveling on a reversing trajectory 506 based on a sequence of locations associated therewith indicating that the hauling machine 504 is traveling in reverse. In such examples, the locations are determined utilizing one or more location sensors (e.g., GPS, etc.) and/or one or more inertial sensors (e.g., accelerometer, etc.).

At operation 512, the processor causes a bed 514 of the hauling machine 504 to raise to a threshold angle 516 based at least in part on the reversing trajectory and the hauling machine being within the first threshold distance of the crushing machine 510. The angle may include an angle associated with substantially no material discharge. In some examples, the angle may include an angle associated with less than a threshold amount of material discharge from the bed 514.

In various examples, the processor may cause the bed 514 to hold at the threshold angle 516 until the hauling machine 504 is within a second threshold distance of the crushing machine 510. In some examples, the processor may cause the bed 514 to hold at the threshold angle 516 until the hauling machine 504 is within the second threshold distance of a discharge location 518 associated with the crushing machine 510. The discharge location 518 may include a location in which the hauling machine 504 stops in order to discharge material from the bed 514 into the crushing machine 510.

At operation 520, the processor causes the bed 514 to raise to an angle greater than the threshold angle based on a determination that the hauling machine 504 is within a second threshold distance of the discharge location 518. In various examples, the processor causes the bed to raise to a discharge angle 522 and/or at a discharge angle rate 524 associated with a particular discharge rate. As discussed above, the discharge rate may be determined based on the discharge location 518, the crusher 510 capacity and/or capability, a fuel capacity associated with the hauling machine 504, a desired fuel efficiency in material discharge (e.g., fuel efficient discharge rate selected), material data associated with the material in the bed 514, and the like.

In various examples, the processor determines an engine speed and/or hydraulic valve position associated with the discharge rate. In such examples, the processor causes the bed to raise to the discharge angle 522 (greater than the threshold angle) and/or at the discharge angle rate 524 by setting the associated engine speed and/or hydraulic valve position.

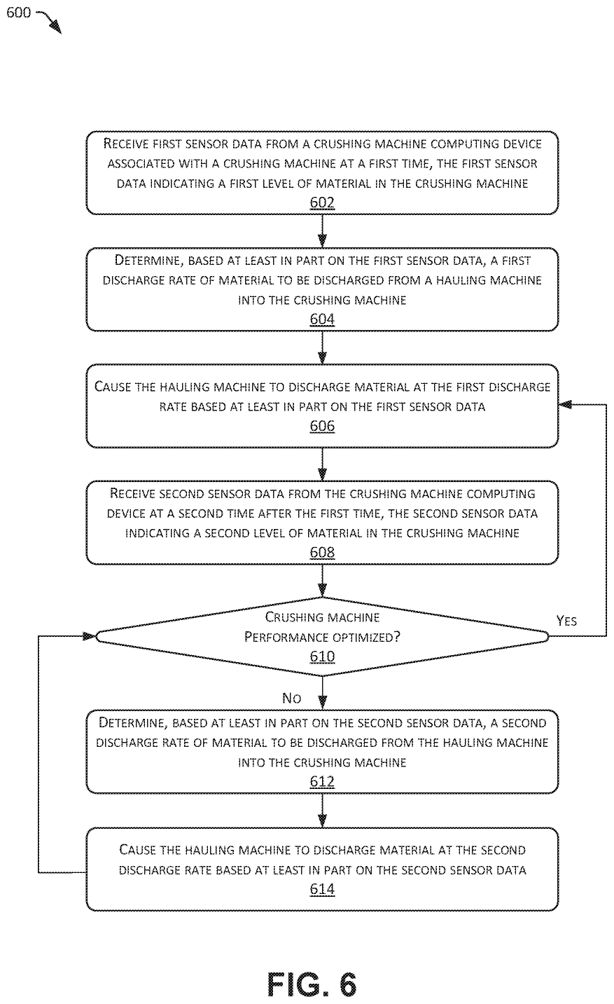

FIG. 6 includes a flow chart depicting a process 600 for causing a hauling machine to discharge material at a rate associated with optimizing a performance of a receiving machine. In at least one example, the receiving machine includes a crushing machine (e.g., crusher). In other examples, the receiving machine includes any other machine configured to receive and/or process material. The process 600 may be performed by a processor associated with a hauling machine computing device, such as hauling machine computing device 120, and/or a worksite management computing device, such as worksite management computing device 106.

At operation 602, the processor receives first sensor data from a crushing machine computing device associated with a crushing machine at a first time, the first sensor data indicating a first level of material in the crushing machine. As discussed above, the crushing machine includes one or more sensors configured to determine the amount of material in the crushing machine. The sensor(s) provide raw and/or processed sensor data to the crushing machine computing device. In some examples, the crushing machine computing device pre-processes the sensor data. In some examples, the crushing machine computing device sends the sensor data directly to the computing device associated with the processor (e.g., hauling machine computing device and/or worksite management computing device). In some examples, the crushing machine computing device stores the sensor data in a datastore associated therewith.

At operation 604, the processor determines, based at least in part on the first sensor data, a first discharge rate of material to be discharged from a hauling machine into the crushing machine. In various examples, the first discharge rate includes a rate associated with optimizing performance of the crushing machine. In such examples, the discharge rate results in the crushing machine maintaining a level of material therein that does not overload or underload the crushing machine.

In some examples, the processor determines the discharge rate based on a capability of the crushing machine. In such examples, the discharge rate is based on the amount of material the crushing machine can process (e.g., tons per hour, etc.). In some examples, the capability of the crushing machine is determined based on a type of machine associated with the crushing machine and/or specifications associated therewith. For example, an impact crusher is configured to process material at a first rate and a cone crusher is configured to process material at a second rate.

In various examples, the capability of the crushing machine is determined based on material data (e.g., a type, composition, and/or characteristics) associated with the material to be processed. In such examples, the amount of material that the crushing machine can process over a time period (e.g., tons per hour) is based in part on a type, composition, and/or characteristic associated with the material. For example, a crushing processes 20 tons of limestone per hour and 13 tons of granite rocks per hour.

At operation 606, the processor causes the hauling machine to discharge material at the first discharge rate based at least in part on the first sensor data. In some examples, the processor determines an engine speed and/or a hydraulic valve position associated with the discharge rate. In such examples, the processor causes the engine to accelerate to the engine speed and/or causes the hydraulic valve to set the hydraulic valve position associated with the discharge rate (e.g., associated with an angle and/or angular rate to cause the material to discharge at the discharge rate).

In examples in which the processor is associated with the worksite management computing devices, the processor sends an instruction to the hauling machine computing device to discharge material at the discharge rate. In some examples, responsive to receiving the instruction to discharge material at the discharge rate, the hauling machine computing device determines the engine speed and/or hydraulic valve position associated therewith. In some examples, the instruction includes the engine speed and/or hydraulic valve position associated with the discharge rate. In such examples, responsive to receiving the instruction, the hauling machine computing device establishes the engine speed and hydraulic valve position associated with the discharge rate.

At operation 608, the processor receives second sensor data from the crushing machine computing device at a second time after the first time, the second sensor data indicating a second level of material in the crushing machine. In some examples, the processor determines that the second time is after the first time based in part on a value of a second time stamp associated with a second time is greater than a value of a first time stamp associated with the first time. The second level of material may include a higher level, a lower level, or substantially the same (e.g., within a threshold difference) level of material in the crushing machine.

At operation 610, the processor determines whether the crushing machine performance is optimized. The performance optimization is based at least in part on the crushing machine not being overloaded or not having a sufficient load to continually produce output. In some examples, the crushing machine performance is determined to be optimized based on a level of material in the crushing machine being above a minimum level (e.g., minimum threshold volume, weight, amount of material, etc.) and below a maximum level (e.g., maximum threshold volume, weight, amount of material, etc.).

Based at least in part on a determination that the performance of the crushing machine is optimized (“Yes” at operation 610), the processor causes the hauling machine to continue discharging material at the first discharge rate, as described at operation 606. In some examples, based on a determination that the performance of the crushing machine remains optimized, the process 600 may continue in a loop until the hauling machine has discharged a load of material (or a portion of the load designated for the crushing machine). In some examples, the process 600 may continue in the loop until the processor determines that the crushing machine performance is not optimized.

Based at least in part on a determination that the performance of the crushing machine is not optimized (“No” at operation 610), the processor, at operation 612 determines, based at least in part on the second sensor data, a second discharge rate of material to be discharged from the hauling machine into the crushing machine. In some examples, the second rate includes a faster rate than the first rate. In such examples, the crushing machine may be underperforming based on the first rate. In some examples, the second rate includes a slower rate than the first rate. In such examples, the first discharge rate overloads the crushing machine.

At operation 614, the processor causes the hauling machine to discharge material at the second discharge rate based at least in part on the second sensor data. In some examples, the processor determines a second engine speed and/or a second hydraulic valve position associated with the second discharge rate. In such examples, the processor causes the engine to accelerate to the second engine speed and/or causes the hydraulic valve to set the second hydraulic valve position associated with the second discharge rate (e.g., associated with an angle and/or angular rate to cause the material to discharge at the second discharge rate).

In some examples, the processor sends a second instruction to the hauling machine computing device to discharge material at the second discharge rate. In some examples, responsive to receiving the second instruction to discharge material at the second discharge rate, the hauling machine computing device determines the second engine speed and/or the second hydraulic valve position associated therewith. In some examples, the second instruction includes the second engine speed and/or the second hydraulic valve position associated with the second discharge rate. In such examples, responsive to receiving the second instruction, the hauling machine computing device establishes the second engine speed and the second hydraulic valve position associated with the second discharge rate.

In various examples, the processor may continuously determine whether the crushing machine performance is optimized, such as described at operation 610, and cause the hauling machine to discharge material at the optimizing discharge rate. Based on a determination, at a time during operation, that the crushing machine performance is not optimized, the processor may determine a third discharge rate, cause the material to be discharged at the third discharge rate, and so on. In some examples, the process 600 may continue in the loop until the processor determines that the hauling machine has discharged a load (or a portion of the load designated for the crusher).

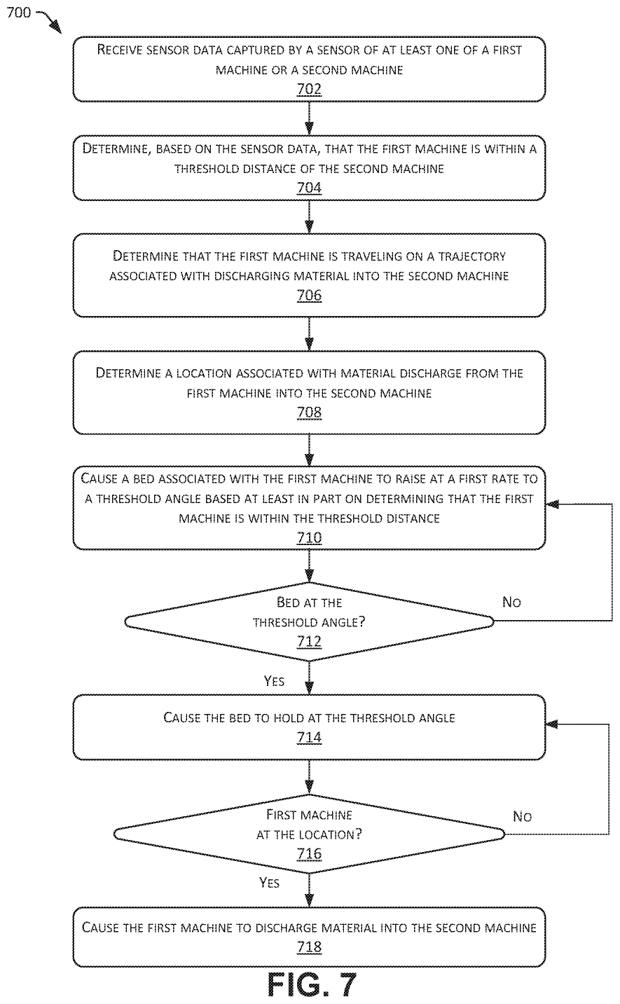

FIG. 7 includes a flow chart depicting a process 700 for causing a bed of a hauling machine to be raised to a threshold angle to reduce a total time the hauling machine is at a discharge location, in accordance with examples of this disclosure. The on-station time includes a time at which the hauling machine remains at a discharge location. In various examples, the threshold angle (e.g., 15 degrees, 20 degrees, 23 degrees, etc.) includes an angle at which material will not discharge from the bed. The process 700 may be performed by a processor associated with a worksite management computing device, such as worksite management computing device 106 or a processor associated with a hauling machine computing device, such as hauling machine computing device 120.

At operation 702, the processor receives sensor data from a sensor associated with at least one of a first machine or a second machine. The sensor may include one or more location sensors, proximity sensors, a near-field communication sensors, Bluetooth sensors, range sensors, or the like. In some examples, the first machine includes a hauling machine and the second machine includes a receiving machine. In such examples, the first machine includes a load of material for discharge into the second machine. In some examples, the second machine includes a crushing machine. In such examples, the first machine and the second machine may be located at a mine site. In some examples, the second machine includes another type of machine configured to receive a load of material or a portion thereof, such as a recycling material processor, a refuse processor, shredders, wood chippers, or the like.

At operation 704, the processor determines, based at least in part on the sensor data, that the first machine is within a threshold distance (e.g., 50 feet, 20 yards, 18 meters, etc.) of a second machine.

At operation 706, the processor determines that the first machine is traveling on a trajectory associated with discharging material into the second machine (e.g., trajectory associated with an approach to the second machine). In some examples, the processor determines that the first machine is on the trajectory associated with discharging material based on a determination that a distance between the first machine and the second machine is decreasing. In some examples, the processor determines that the first machine is on the trajectory associated with discharging material based on a determination that a transmission of the first machine is in reverse. In some examples, the processor determines that the first machine is on the trajectory associated with discharging material based on a determination that the first machine is on a reversing trajectory toward the second machine.

At operation 708, the processor determines a location associated with material discharge from the first machine into the second machine. In some examples, the location includes a location on a map (e.g., latitude/longitude, grid coordinate, etc.) associated with material discharge from the first machine into the second machine. For example, the location may include a designated location on a map used by the first machine to navigate in and around a worksite.

In some examples, the location includes a distance (e.g., 2 feet, 1 meter, etc.) between the first machine and the second machine. In some examples, the distance is determined based on one or more characteristics of the first machine. The characteristics of the first machine include a type, size, bed shape, bed lift pattern, and the like. In some examples, the distance is determined based on one or more characteristics of the second machine. The characteristics of the second machine include a type, a size, a receiving area (e.g., size, shape, angle, etc.), and the like.

At operation 710, the processor causes a bed associated with the first machine to raise at a first rate to a threshold angle (e.g., 10 degrees, 15 degrees, 24 degrees, etc.) based at least in part on determining that the first machine is within the threshold distance. In some examples, the threshold angle includes an angle associated with no discharge or substantially no discharge from the bed of the first machine (e.g., less than a threshold amount (e.g., 1 pound, 2 kilograms, etc.) of material discharged). In such examples, the threshold angle includes a bed angle at which a force of friction holding the load in place overcomes a force of gravity such that the load does not discharge from the bed.

In some examples, the threshold angle is based in part on the characteristic(s) of the first machine. In some examples, the threshold angle is based in part on material data associated with the material loaded in the bed. In such examples, the threshold angle may be determined based in part on a type, composition, and/or characteristics of the material. For example, a hauling machine with a load of gravel may include a first threshold angle and the hauling machine with a load of large rocks may include a second threshold angle. In various examples, the threshold angle may be stored on a computing device associated with the processor, such as in a look-up table.

At operation 712, the processor determines whether the bed is at the threshold angle. In some examples, the first machine includes a sensor configured to determine the angle of the bed. In such examples, the processor determines whether the bed is at the threshold angle based on sensor data from the sensor.

Based on a determination that the bed is not at the threshold angle (“No” at operation 712), the processor continues to cause the bed to raise at the first rate to the threshold angle, as described at operation 712.

Based on a determination that the bed is at the threshold angle (“Yes” at operation 712), the processor, at operation 714, causes the bed to hold at the threshold angle. In some examples, the first machine will continue on the trajectory associated with discharging the material with the bed at the threshold angle. In such an example, the first machine may approach the second machine with the bed raised at an angle that will not result in discharge of the material.

At operation 716, the processor determines whether the first machine is at the location. In some examples, the processor determines the first machine is at the location based on location data from one or more location sensors (e.g., GPS, etc.).

As discussed above, in some examples, the location includes a distance between the first machine and the second machine. In some examples, the first machine and/or the second machine may include proximity sensors configured to determine the distance between the first machine and the second machine. In such examples, based on an indication from the proximity sensor that the first vehicle is at the distance from the second machine, the processor determines that the first machine is at the location.

Based on a determination that the first machine is not at the location (“No” at operation 716), the processor continues to cause the bed to hold at the threshold angle as described at operation 714. The first machine may continue on the trajectory associated with discharging the material (e.g., trajectory toward the second machine).

Based on a determination that the first machine is at the location (“Yes” at operation 716), the processor, at operation 718, causes the first machine to discharge the material into the second machine. In some examples, the processor causes the bed to lift above the threshold angle to discharge material into the second machine.

In some examples, the processor determines a discharge rate associated with the material. As discussed above, the discharge rate may be based on an input from an operator, an input from a remote computing device (e.g., a worksite management computing device, a computing device associated with the second machine, etc.), a capability and/or capacity of the second machine (e.g., based on machine data associated therewith, such as that received from a remote computing device), a pre-set discharge rate associated with the first machine, the location associated with the material discharge, or the like.

In various examples, the processor determines an engine speed and/or hydraulic valve position associated with the discharge rate. In some examples, the processor determines a second rate associated with raising the bed that corresponds to the discharge rate. In such examples, the processor causes the bed to raise at the second rate to discharge the material at the discharge rate.

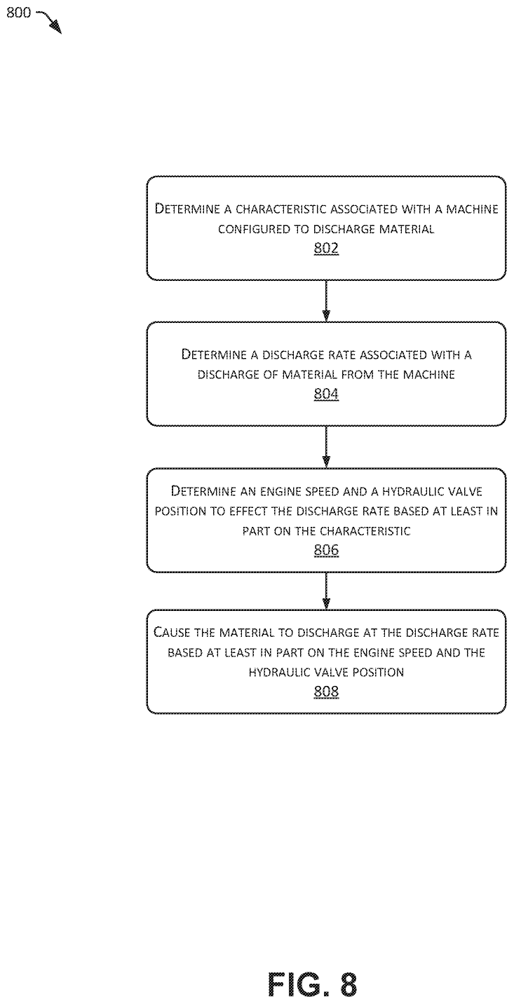

FIG. 8 includes a flow chart depicting a process 800 for modifying an engine speed or a hydraulic valve rate to discharge material at a discharge rate based on a characteristic of the associated hauling machine, in accordance with examples of this disclosure. The process 800 may be performed by a processor associated with a worksite management computing device, such as worksite management computing device 106 or a processor associated with a hauling machine computing device, such as hauling machine computing device 120.

At operation 802, the processor determines a characteristic associated with a machine configured to discharge material. The machine includes a hauling machine, such as hauling machine 102, or any other type of machine configured to carry and discharge a load of material. The characteristic(s) include engine size, horsepower, hydraulic reservoir capacity, hydraulic system size, hydraulic system components (e.g., valve size, robustness, etc.), and the like. In some examples, the characteristic(s) may be indicative of a weak point (e.g., a least robust component) and/or a strong point (e.g., a most robust component) associated with machine bed operation.

At operation 804, the processor determines a discharge rate associated with a discharge of material from the machine. As discussed above, the discharge rate may be based on an input from an operator, an input from a remote computing device (e.g., a worksite management computing device, a computing device associated with the second machine, etc.), a capability and/or capacity of the second machine (e.g., based on machine data associated therewith, such as that received from a remote computing device), a pre-set discharge rate associated with the first machine, the location associated with the material discharge, or the like.

At operation 806, the processor determines an engine speed and a hydraulic valve position to affect the discharge rate, based at least in part on the characteristic. In some examples, the processor determines the engine speed and the hydraulic valve position to stress both the engine system and hydraulic system substantially equally (e.g., not straining one system substantially greater than the other). In some examples, the processor determines a stronger system (e.g., more robust, larger, has stronger components, requires less maintenance, etc.) to rely on more substantially to lift the bed. In such examples, the processor determines, based on the characteristic, the engine speed and the hydraulic valve position based on the stronger system. For example, a machine including a small engine and a robust hydraulic system receives an input to discharge material at a maximum discharge rate. The processor determines to set the engine at a medium speed and a hydraulic valve at a position to cause the hydraulic system to carry the burden of lifting the bed. In such an example, the machine relies more on the robust hydraulic system for the bed lift, while preserving the operational life of the small engine. For another example, a machine including a large engine and a hydraulic system with a weak component receives an input to discharge material at a maximum discharge rate. The processor determines to set an engine speed to maximum to cause the engine to carry the burden of lifting the bed. In such an example, the processor relies heavily on the large engine to lift the bed, while preserving the operational life of a weaker hydraulic system.

At operation 808, the processor causes the material to discharge at the discharge rate based at least in part on the engine speed and the hydraulic valve position. In various examples, the processor is configured to preserve the operational life of the engine system and/or the hydraulic system by setting the engine speed and the hydraulic valve position based on the characteristic of the machine. In such examples, the techniques described herein improve the functioning of the machine by at least preserving the operational capabilities thereof.

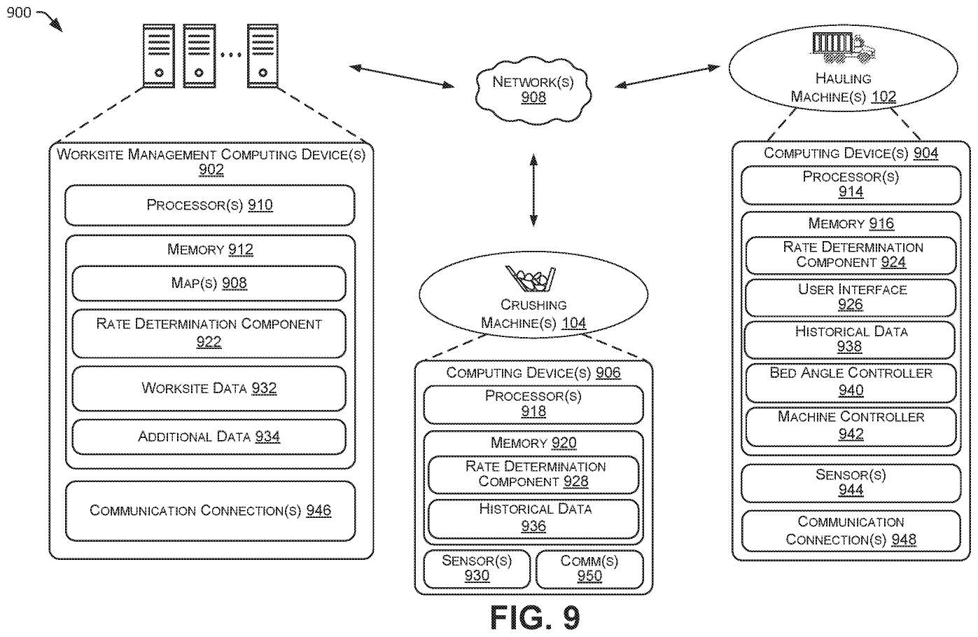

FIG. 9 is an illustration of an example system 900 for implementing the techniques described herein. For example, FIG. 9 illustrates example computing devices including worksite management computing device(s) 902, one or more hauling machine computing devices 904, and one or more crushing machine computing devices 906, that interact over a network 908. The network(s) 908 represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the worksite management computing device(s) 902, the hauling machine computing device(s) 904, and/or the crushing machine computing device(s) 906 communicate with one another.

By way of example and not limitation, the worksite management computing device(s) 902 may be or may include worksite management computing device(s) 106, the hauling machine computing device(s) 904 may be or may include the hauling machine computing device(2) 120 associated with the hauling machine 102, and the crushing machine computing device(s) 906 may be or may include the crushing machine computing device 122 associated with the crushing machine 104.

The worksite management computing device(s) 902 may include one or more individual servers or other computing devices that may be physically located in a single central location or may be distributed at multiple different locations. The worksite management computing device(s) 902 may be hosted privately by an entity administering all or part of a worksite management network (e.g., a construction company, mining company, etc.), or may be hosted in a cloud environment, or a combination of privately hosted and cloud hosted services.

Each of the computing devices described herein include one or more processors and/or memory. Specifically, in the illustrated example, worksite management computing device(s) 902 include one or more processors 910 and memory 912, hauling machine computing device(s) 904 include one or more processors 914 and memory 916, crushing machine computing device(s) 906 includes one or more processors 918 and memory 920. By way of example and not limitation, the processor(s) may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The memory (e.g., memories 912, 916, 920) may comprise one or more non-transitory computer-readable media and may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

As shown in FIG. 9, worksite management computing device(s) 902 include a rate determination component 922, hauling machine computing device(s) 904 includes a rate determination component 924 with a user interface 926, and crushing machine computing device(s) 906 includes rate determination component 928. In various examples, the rate determination components (e.g., rate determination components 922, 924, and/or 928) are configured to determine a discharge rate of material from the hauling machine 102. As discussed above, the discharge rate may be based on an input from an operator (e.g., via the user interface 926), an input from a remote computing device (e.g., a worksite management computing device, a computing device associated with the second machine, etc.), a capability and/or capacity of the second machine (e.g., based on machine data associated therewith, such as that received from a remote computing device), a pre-set discharge rate associated with the first machine, the location associated with the material discharge, or the like. For example, the worksite management computing device(s) 902 receives sensor data associated with a level of material in the crushing machine, such as that generated by sensors 930, and determines the discharge rate based at least in part on the level of material in the crushing machine 104.

In some examples, the worksite management computing device(s) 902 stores worksite data 932, such as worksite data 114 in the memory 912. As discussed above, the worksite data 932 includes material data (e.g., the type, composition and/or characteristic(s) of the material at the worksite), as well as additional information about the worksite, such as a worksite identifier (unique identifier associated with the worksite), machine identifiers (e.g., identifiers associated with hauling machine(s) 102, crushing machine(s) 104, etc.), machine locations (e.g., current locations of various machines operating in the worksite), machine data (e.g., size, capability, current load, capacity, etc.). In various examples, the rate determination component 922 and/or the rate determination component 924 determine the discharge rate based at least in part on worksite data 932.

In the illustrative example, the worksite management computing device(s) 902 stores additional data 934. The additional data may include historical data associated with hauling machine(s) 102 (e.g., previous discharge rates, etc.), historical data associated with crushing machine(s) 104 (e.g., material receiving rates, processing rates, etc.), current machine system data (e.g., engine oil level, hydraulic reservoir level, etc.), and the like. In some examples, the crushing machine computing device(s) 906 include historical data 936 and the hauling machine computing device(s) 904 include historical data 938. The historical data 936 includes historical data associated with the crushing machine(s) 104 (e.g., material receiving rates, processing rates, etc.). The historical data 938 includes historical data associated with the operation of the hauling machine(s) 102 (e.g., discharging rates, locations of discharge, etc.). In some examples, the historical data 936 and the historical data 938 include data associated with servicing (e.g., maintenance history) the crushing machine(s) 104 and the hauling machine(s) 102, respectively, and/or other data associated with the functioning of the crushing machine(s) 104 and the hauling machine(s) 102, respectively.

In various examples, the hauling machine computing device(s) 904 include a bed angle controller 940, such as bed angle controller 134. The bed angle controller 940 controls an angle and/or angular rate of a bed of the hauling machine(s) 102, such as to discharge material therefrom. In some examples, the bed angle controller 940 determines an engine speed and/or a hydraulic valve position associated with a discharge rate, such as that determined by the rate determination component 924 and/or provided by the rate determination component 922 and/or the rate determination component 928.

In some examples, the bed angle controller 940 determines the engine speed and/or hydraulic valve position based on one or more characteristics associated with the hauling machine(s) 102. The characteristic(s) include engine size, horsepower, hydraulic reservoir capacity, hydraulic system size, hydraulic system components (e.g., valve size, robustness, etc.), and the like. In some examples, the characteristic(s) may be indicative of a weak point (e.g., a least robust component) associated with bed operation and/or a strongest component (e.g., most robust component) associated with the bed operation.

In various examples, the bed angle controller 940 is configured to establish the engine at the engine speed and the hydraulic valve position to the designated position, in order to discharge material at the determined discharge rate. In various examples, the bed angle controller 940 establishes the engine speed and the hydraulic valve position automatically, such as without additional operator input. In such examples, the techniques described herein improve current manual discharge systems that are complicated for an operator to manipulate.

In some examples, the hauling machine(s) 102 include autonomous or semi-autonomous machines. In such examples, the hauling machine(s) 102 are configured to control the machine between various locations at a worksite, such as to pick up a load of material and to discharge the load of material. In various examples, the hauling machine computing device(s) 904 includes a machine controller 942 to control the machine. The machine controller controls one or more systems (e.g., engine system, drive system, etc.) to cause the hauling machine(s) 102 to travel between the locations at the worksite. In some examples, the machine controller receives commands from the worksite management computing device(s) 902, the commands including trajectories, locations to travel to, and/or other instructions associated with the operation of the hauling machine(s) 102. In such examples, the machine controller 942 controls the machine based on the commands. In some examples, the hauling machine computing device(s) 904 determine one or more trajectories to follow to navigate between locations at the worksite. In such examples, the machine controller 942 controls the machine based on the trajectories.

In various examples, the hauling machine computing device(s) 904 includes one or more sensors 944. The sensor(s) 944 and/or sensor(s) 930 may include capacity sensors (e.g., determine an amount of material in a respective machine), location sensors (e.g., global positioning system (GPS), compass, etc.), inertial sensors (e.g., inertial measurement units, accelerometers, magnetometers, gyroscopes, etc.), distance sensors (e.g., laser rangefinder, etc.), lidar sensors, radar sensors, cameras (e.g., RGB, IR, intensity, depth, time of flight, etc.), audio sensors, ultrasonic transducers, sonar sensors, environment sensors (e.g., temperature sensors, humidity sensors, light sensors, pressure sensors, etc.), and the like.

As shown in FIG. 9, worksite management computing device(s) 902 include communications connection(s) 946, hauling machine computing device(s) 904 include communications connection(s) 948, and crushing machine computing device(s) 906 include communications connection(s) 950 that enable communication between at least the worksite management computing device(s) 902 and one or more of the hauling machine computing device(s) 904 and the crushing machine computing device(s) 906.

The communication connection(s) 946, 948, and/or 950 include physical and/or logical interfaces for connecting worksite management computing device(s) 902, hauling machine computing device(s) 904, and/or crushing machine computing device(s) 906 to another computing device or the network 908. For example, the communications connection(s) 946, 948, and/or 950 can enable Wi-Fi-based communication such as via frequencies defined by the IEEE 802.11 standards, short range wireless frequencies such as Bluetooth®, cellular communication (e.g., 2G, 2G, 4G, 4G LTE, 5G, etc.) or any suitable wired or wireless communications protocol that enables the respective computing device to interface with the other computing device(s).

As described above, the hauling machine computing device 904 may include a user interface 926, such as user interface 206. In some examples, the user interface 926 enables an operator of the hauling machine(s) 102 to manipulate a rate of discharge of material from the hauling machine(s) 102, such as by inputting a desired discharge rate. In some examples, the user interface 926 includes one or more selectable options for the operator to select the discharge rate (e.g., as illustrated in FIG. 2). In some examples, the user interface 926 includes a rotary knob for selecting the discharge rate.

In various examples, the user interface 926 includes a display configured to receive discharge rate and/or other input from the operator. Depending on the type of computing device(s) used as the hauling machine computing device 904, the display may employ any suitable display technology. For example, the displays may be a liquid crystal display, a plasma display, a light emitting diode display, an OLED (organic light-emitting diode) display, an electronic paper display, or any other suitable type of display able to present digital content thereon. In some examples, the displays may have a touch sensor associated with the displays to provide a touchscreen display configured to receive touch inputs for enabling interaction with a graphic interface (e.g., user interface 926) presented on the display. Accordingly, implementations herein are not limited to any particular display technology.

While FIG. 9 is provided as an example system 900 that can be used to implement techniques described herein, the techniques described and claimed are not limited to being performed by the system 900, nor is the system 900 limited to performing the techniques described herein.

### INDUSTRIAL APPLICABILITY

The present disclosure provides systems and methods for causing a hauling machine 102 to discharge material at a particular discharge rate based on one or more conditions. The condition(s) include a level of material associated with a crushing machine 104 receiving the material, a location associated with the hauling machine 102, a capability and/or capacity of the crushing machine 104 (e.g., based on machine data associated therewith, such as that received from a remote computing device), a pre-set discharge rate associated with the hauling machine 102, or the like. Based on a determination of the particular discharge rate and/or a command to discharge material, a hauling machine computing device 120 may determine an engine speed 210 and/or hydraulic valve position 212 associated with the particular discharge rate. The hauling machine computing device 120 may automatically establish the engine speed 210 and/or the hydraulic valve position 212, to discharge material at the particular discharge rate.

The automated hauling machine discharge techniques described herein reduce the workload associated with an operator of the machine. For example, an operator of the machine inputs, via a selectable knob or other input device, a discharge rate for the machine to discharge material. A computing device associated with the machine automatically determines an engine speed and/or hydraulic valve position associated with the discharge rate and causes the machine to discharge material at the discharge rate based on the operator input. In another example, the computing device receives the input associated with the discharge rate from a remote computing device. Responsive to receiving the input from the remote computing device and/or a command to begin discharging material, the computing device associated with the machine may automatically discharge the material at the discharge rate. Accordingly, the present disclosure decreases the operator workload.

Additionally, the techniques described herein improve the operation of a receiving machine, such as a crushing machine 104. The crushing machine is configured to receive the material from the hauling machine 102. The crushing machine 104 processes the material, such as by crushing the material to make small rocks, sand, or the like. If a crushing machine 104 receives an excessive amount of material at once, the crushing machine 104 may be overloaded and may be unable to function optimally and/or may overheat or otherwise break down. If the crushing machine 104 receives material at too slow a rate, it may underperform, such as by not producing the small rocks, sand, etc. at an optimal rate. The systems and methods described herein include receiving sensor data 412 from the crushing machine 104 indicating a level of material in the crushing machine. A computing device may determine, based on the sensor data 412, a discharge rate of material from a hauling machine 102 into the crushing machine 104 to minimize and/or eliminate instances of overfilling or underfilling (and potentially damaging) the crushing machine 104. By optimizing the level of material in the crushing machine, the techniques described herein may keep the crushing machine 104 running at or close to a maximum capacity and/or design rate. Accordingly, the present disclosure improves the operation of the crushing machine 104. Additionally, minimizing instances of the crushing machine being overfilled reduces the likelihood of damage thereto, thereby avoiding unnecessary downtime and minimizing maintenance costs and lost profit due to unscheduled maintenance.

While aspects of the present disclosure have been particularly shown and described with reference to the embodiments above, it will be understood by those skilled in the art that various additional embodiments are contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed:

1. A system, comprising:
one or more processors; and
one or more computer-readable media storing instructions that, when executed by the one or more processors, cause the one or more processors to perform operations comprising:
receiving data associated with a discharge of material from a hauling machine;
determining a discharge rate based at least in part on the data;
determining an engine speed and a hydraulic valve position associated with the discharge rate; and
causing the hauling machine to discharge the material at the discharge rate based at least in part on the engine speed and the hydraulic valve position.

2. The system of claim 1, wherein the operations further comprise:
identifying a crushing machine configured to receive the material from the hauling machine;
receiving sensor data generated by a sensor, the sensor being carried by the crushing machine; and
determining, based at least in part on the sensor data, a level of material in the crushing machine,
wherein the discharge rate is determined based at least in part on the level of material in the crushing machine.

3. The system of claim 2, wherein the sensor data comprises first sensor data received at a first time, and wherein the operations further comprise:
receiving second sensor data generated by the sensor at a second time;
determining, based at least in part on the second sensor data, a second level of material in the crushing machine;
determining a second discharge rate associated with discharging the material based at least in part on the second level of material in the crushing machine; and
causing the hauling machine to discharge the material at the second discharge rate.

4. The system of claim 1, wherein the operations further comprise:
determining a characteristic associated with the hauling machine, the characteristic comprising at least one:
an engine size;
an engine horsepower,
a hydraulic reservoir capacity;
a hydraulic valve size; or
a hydraulic system component,
wherein the engine speed and the hydraulic valve position are determined based at least in part on the characteristic.

5. The system of claim 1, wherein receiving the data associated with the discharge rate comprises:
receiving an input indicative of the discharge rate via a user interface associated with the hauling machine.

6. The system of claim 1, wherein the data comprises location data captured by a location sensor and wherein the operations further comprise:
determining a location associated with the hauling machine based at least in part on the location data; and
determining that the location is associated with at least one of:
a crushing machine;
an overburden pile;
a leach field; or
a stock pile,
wherein the discharge rate is determined based at least in part on the location.

7. The system of claim 1, wherein the operations further comprise:
determining that the hauling machine is disposed at a location within a threshold distance of a discharge location;
determining that a trajectory associated with the hauling machine at the location is indicative of an approach to the discharge location; and
based at least in part on the location and the trajectory, causing a bed of the hauling machine to raise to a threshold angle, wherein the threshold angle is associated with less than a threshold amount of material being discharged from the hauling machine.

8. The system of claim 1, wherein the discharge rate is based at least in part on at least one of:
a capability of a receiving machine;
a capacity of the receiving machine;
a type of material associated with the material;
a composition of the material; or
one or more characteristics associated with the material.

9. A method, comprising:
receiving data associated with a discharge of material from a hauling machine;
determining a discharge rate based at least in part on the data;
determining at least one of an engine speed or a hydraulic valve position associated with the discharge rate; and
causing the hauling machine to discharge the material at the discharge rate based at least in part on the at least one of the engine speed and the hydraulic valve position.

10. The method of claim 9, further comprising:
identifying a crushing machine configured to receive the material from the hauling machine;
receiving sensor data generated by a sensor of the crushing machine; and
determining, based at least in part on the sensor data, a level of material in the crushing machine,
wherein the discharge rate is determined based at least in part on the level of material in the crushing machine.

11. The method of claim 10, wherein the sensor data comprises first sensor data received at a first time, and wherein the method further comprises:
receiving second sensor data generated by the sensor at a second time;
determining, based at least in part on the second sensor data, a second level of material in the crushing machine;
determining a second discharge rate associated with discharging the material based at least in part on the second level of material in the crushing machine; and
causing the hauling machine to discharge the material at the second discharge rate.

12. The method of claim 9, further comprising:
identifying a crushing machine configured to receive the material from the hauling machine;
determining material data associated with the material to be discharged into the crushing machine; and
determining a capability of the crushing machine to process the material, based at least in part on the material data,
wherein the discharge rate is determined based at least in part on the capability of the crushing machine to process the material.

13. The method of claim 9, further comprising:
determining a characteristic associated with the hauling machine, the characteristic comprising at least one:
an engine size;
an engine horsepower,
a hydraulic reservoir capacity;
a hydraulic valve size; or
a hydraulic system component,
wherein the engine speed and the hydraulic valve position are determined based at least in part on the characteristic.

14. The method of claim 9, wherein receiving the data associated with the discharge rate comprises:
receiving an input indicative of the discharge rate via a user interface associated with the hauling machine.

15. The method of claim 9, further comprising:
determining that the hauling machine is disposed at a location within a threshold distance of a discharge location;
determining that a trajectory associated with the hauling machine at the location is indicative of an approach to the discharge location; and
based at least in part on the location and the trajectory, causing a bed of the hauling machine to raise to a threshold angle, wherein the threshold angle is associated with less than a threshold amount of material being discharged from the hauling machine.

16. The method of claim 9, further comprising:
determining a location associated with the hauling machine; and
determining that the location is associated with at least one of:
a crushing machine;
an overburden pile;
a leach field; or
a stock pile,
wherein determining the discharge rate is based at least in part on the location.

17. A hauling machine disposed at a worksite, the hauling machine comprising:
a bed configured to carry material;
one or more processors; and
one or more computer-readable media storing instructions that, when executed by the one or more processors, cause the one or more processors to perform operations comprising:
receiving, via a user interface, an input indicative of a discharge rate associated with discharging the material from the bed;
determining at least one of an engine speed or a hydraulic valve position associated with the discharge rate; and
causing the material to be discharged from the bed at the discharge rate based at least in part on the at least one of the engine speed and the hydraulic valve position.

18. The hauling machine of claim 17, wherein the operations further comprise:
determining a characteristic associated with the hauling machine, the characteristic comprising at least one:
an engine size;
an engine horsepower,
a hydraulic reservoir capacity;
a hydraulic valve size; or
a hydraulic system component,
wherein determining the at least one of the engine speed or the hydraulic valve position is based at least in part on the characteristic.

19. The hauling machine of claim 17, wherein:
the at least one of the engine speed or the hydraulic valve position modify at least one of an angle of the bed or an angular rate of the bed, and
modifying the at least one of the angle of the bed or the angular rate of the bed causes the material to be discharged at the discharge rate.

20. The hauling machine of claim 17, wherein the operations further comprise:
determining that the hauling machine is disposed at a location within a threshold distance of a discharge location;
determining that a trajectory associated with the hauling machine at the location is indicative of an approach to the discharge location; and
based at least in part on the location and the trajectory, causing the bed of the hauling machine to raise to a threshold angle, wherein the threshold angle is associated with less than a threshold amount of material being discharged from the hauling machine.
